(19) United States
(12) Patent Application Publication
(10) Pub. No.: US 2015/0202975 A1
(43) Pub. Date: Jul. 23, 2015

(54) COMMUNITY SHARING OF ELECTRIC VEHICLE CHARGING PORTS

(71) Applicants: James Solomon, Saratoga, CA (US); Milton T. Tormey, Los Altos, CA (US)

(72) Inventors: James Solomon, Saratoga, CA (US); Milton T. Tormey, Los Altos, CA (US)

(21) Appl. No.: 14/604,511

(22) Filed: Jan. 23, 2015

Related U.S. Application Data
(60) Provisional application No. 61/930,943, filed on Jan. 23, 2014.

(51) Int. Cl. B60L 11/18; G06Q 10/06

(52) U.S. Cl. CPC B60L 11/1838; G06Q 10/06316

(57) ABSTRACT

A method and apparatus for generating and managing community sharing and queuing for electric vehicle charging ports is described. Upon a charging port becoming available or about to become available, a notification is sent to an EV operator that is in the queue that indicates that they can use the charging port. The notification may allow the EV operator to accept and acknowledge the availability of the charging port that provides their intention to use the charging port and may allow the EV operator to pass on using the charging port. If the EV operator accepts, the charging port will be placed on hold for at least a predefined amount of time such that only that electric vehicle operator may use that charging port. If the EV operator passes, a notification is sent to another EV operator in the queue (if any) indicating that they can use the charging port.

### CROSS-REFERENCE TO RELATED APPLICATIONS

This application claims the benefit of U.S. Provisional Application No. 61/930,943, filed Jan. 23, 2014, which is hereby incorporated by reference.

### FIELD

Embodiments of the invention relate to the field of charging electric vehicles; and more specifically to community sharing and queuing of electric vehicle charging ports.

### BACKGROUND

Electric vehicle charging stations provide charging services for electric vehicles (e.g., electric battery powered vehicles, gasoline/electric battery powered vehicle hybrids, etc.). Charging stations may be located in designated charging locations (e.g., similar to a gas station), near or associated with parking spaces (e.g., public parking spaces and/or private parking space), or other locations.

Each electric vehicle charging station may include one or more charging ports that each couples to an electric vehicle. Example charging ports include a power receptacle (sometimes referred to as level 1 charging) that is configured to accept plugs of a charging cord, a level 2 charging port, a level 3 charging port, and/or circuitry for inductive charging. The power receptacle may be any type of power receptacle such as those conforming to National Electrical Manufacturers Association (NEMA) standards 5-15, 5-20, and 14-50 or other standards (e.g., BS 1363, CEE7, etc.) and may be operating at different voltages (e.g., 120V, 240V, 230V, etc.). The level 2 and level 3 charging ports typically include circuitry for an attached charging cord having a standard connector (e.g., SAE J1772). Level 2 charging typically allows charging at 208-240 V AC. Level 3 charging typically allows charging between 300-600 V DC. An inductive charging port allows electric vehicles to be charged using inductive charging. The charging port(s) on a charging station can be used independently. For example, one electric vehicle can be plugged into a power receptacle charging port while another electric vehicle may be coupled with a level 2 charging port.

Although more and more electric vehicle charging stations are being installed, the availability of certain charging stations in a given location may be limited and may not be enough to meet demand. As a result, electric vehicle operators may, during periods of high demand, experience difficulty in locating an electric vehicle charging station that is available for charging. For example, some workplaces have relatively few electric vehicle charging ports and far more electric vehicle operators. This is sometimes referred to as oversubscription where demand for charging ports exceeds the number of charging ports.

### SUMMARY

A method and apparatus for generating and managing community sharing and queuing for electric vehicle charging ports is described herein. In one embodiment, a queue of electric vehicle operators is generated for one or more charging ports. Upon a port becoming available or about to become available, a notification is sent to the electric vehicle operator that is at the front of the queue that indicates that it is their turn to use the charging port. The notification may be sent through various ways including a text message, an email message, an instant message, and/or through a mobile application notification. The notification may allow the electric vehicle operator to accept and acknowledge the availability of the charging port that provides their intention to use the charging port (e.g., connect their electric vehicle to that charging port). The notification may allow the electric vehicle operator to pass on using the charging port. If the electric vehicle operator accepts, the charging port will be placed on hold for at least a predefined amount of time such that only that electric vehicle operator may use that charging port. If the electric vehicle operator passes, a notification is sent to the electric vehicle operator that is next in line in the queue (if there is any). The electric vehicle operator will receive a notification requiring them to stop using the charging port (and potentially move their electric vehicle) such that another operator may use the charging port when or about when charging has reached a predefined limit such as the electric vehicle being fully charged, a predefined state-of-charge, a maximum time limit, and/or a maximum amount of energy has been delivered.

In some embodiments, the queuing service may allow electric vehicle operators to request an action from a different electric vehicle operator that is charging or a person at a different spot in the queue. An example action may be to change places in the electric vehicle queue. Another action is to request the EV operator currently charging to free up the charging port.

### BRIEF DESCRIPTION OF THE DRAWINGS

The invention may best be understood by referring to the following description and accompanying drawings that are used to illustrate embodiments of the invention. In the drawings:

FIG. 1 is a diagram that illustrates an exemplary system for community sharing and queuing of one or more charging ports according to one embodiment;

FIG. 2 is a flow diagram that illustrates exemplary operations for community sharing of one or more charging ports according to one embodiment;

FIG. 3 is a flow diagram that illustrates exemplary operations for community sharing of one or more charging ports when an EV operator has accepted the use of a charging port according to one embodiment;

FIG. 4 illustrates exemplary operations performed in response to detecting that an EV has been disconnected from a charging port that is in community mode according to one embodiment;

FIG. 5 is a flow diagram that illustrates exemplary operations for responding to a message from an EV operator whose turn it is to use a charging port that the port is unavailable according to one embodiment;

FIG. 6 is a flow diagram illustrating exemplary operations for an EV operator to request the EV operator who is currently charging to free up the charging port so that the requesting EV operator can use the charging port according to one embodiment;

FIG. 7 is a flow diagram illustrating exemplary operations for an EV operator to request another queued EV operator to swap positions in the queue according to one embodiment;

FIG. 8 is a system diagram illustrating exemplary operations performed for multiple EV operators are waiting in a queue for access to a charging port according to one embodiment;

FIG. 9 is a system diagram illustrating exemplary operations performed for multiple EV operators are waiting in a queue for access to a charging port according to one embodiment;

FIG. 10 illustrates a state diagram of the states of an EV operator during queuing according to one embodiment;

FIG. 11 illustrates an exemplary user interface for a vehicle operator to locate charging port(s) of interest and add themselves to one or more queues for one or more of those charging ports according to one embodiment;

FIG. 12 is a block diagram that illustrates more details of the network server according to one embodiment;

FIG. 13 illustrates an exemplary embodiment of a charging station according to one embodiment; and

FIG. 14 is a block diagram illustrating an exemplary architecture of a data processing system that may be used in some embodiments.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

A method and apparatus for generating and managing community sharing and queuing for electric vehicle charging ports is described herein. In one embodiment, a queue of electric vehicle operators is generated for one or more charging ports. Upon a port becoming available or about to become available, a notification is sent to the electric vehicle operator that is at the front of the queue that indicates that it is their turn to use the charging port. The notification may be sent through various ways including a text message, an email message, an instant message, and/or through a mobile application notification. The notification may allow the electric vehicle operator to accept and acknowledge the availability of the charging port that provides their intention to use the charging port (e.g., connect their electric vehicle to that charging port). The notification may allow the electric vehicle operator to pass on using the charging port. If the electric vehicle operator accepts, the charging port will be placed on hold for at least a predefined amount of time such that only that electric vehicle operator may use that charging port. If the electric vehicle operator passes, a notification is sent to the electric vehicle operator that is next in line in the queue (if there is any). The electric vehicle operator will receive a notification requiring them to stop using the charging port (and potentially move their electric vehicle) such that another operator may use the charging port when or about when charging has reached a predefined limit such as the electric vehicle being fully charged, a predefined state-of-charge, a maximum time limit, and/or a maximum amount of energy has been delivered.

In some embodiments, the queuing service may allow electric vehicle operators to request an action from a different electric vehicle operator that is charging or a person at a different spot in the queue. An example action may be to change places in the electric vehicle queue. Another action is to request the EV operator currently charging to free up the charging port.

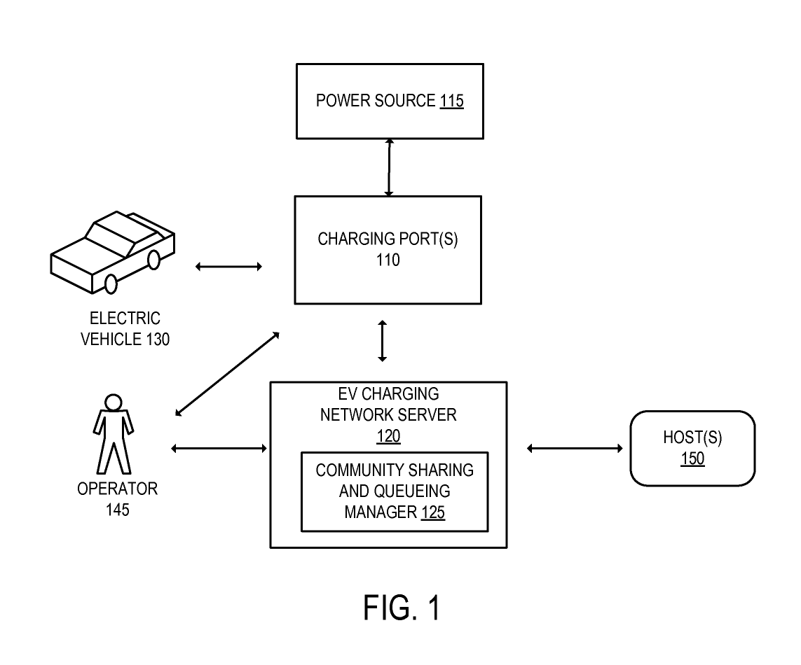

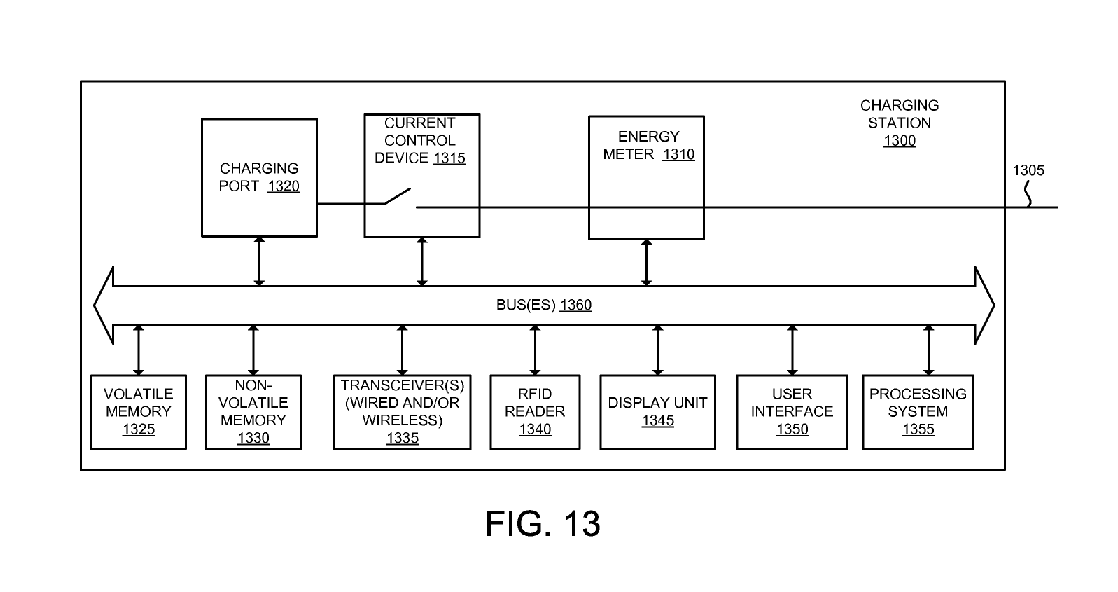

FIG. 1 is a diagram that illustrates an exemplary system for community sharing and queuing of one or more charging ports according to one embodiment. The system includes one or more charging port(s) 110 that are each configured to be coupled to an electric vehicle so that energy can be transferred between an electric vehicle 130 and the power source 115. Although not illustrated in FIG. 1, the charging port(s) 110 may be included within or managed by one or more electric vehicle charging stations. The electric vehicle charging station(s) may include control and logic to manage the charging port(s) including determining whether to enable the charging port for charging. An exemplary charging station that may be used in embodiments described herein will be described with respect to FIG. 13. The direction of the energy transfer may be from the power source 115 to the electric vehicle 130, or from the electric vehicle 130 to the power source 115 (vehicle-to-grid (V2G)). The power source 115 may be a local power grid or other power source.

The charging port(s) 110 may include a power receptacle (sometimes referred to as level 1 charging port) that is configured to accept plugs of a charging cord, circuitry for an attached cord (e.g., a level 2 or level 3 charging port), and/or circuitry for inductive charging. Throughout this description the phrase plugging in and plugging out may be used to refer to an electric vehicle being connected and disconnected from a charging port. However it should be understood that in some circumstances there may not be anything physically plugged into the charging port and/or into the EV. For example, in cases of level 1 charging, typically an electric vehicle (EV) operator plugs one end of the charging cord into the charging port and attaches the other end of the charging cord to the EV. In cases of level 2 or level 3 charging, typically the charging cord is attached to the charging port and the EV operator only attaches the other end of the charging cord to the EV. In cases of inductive charging there are no charging cords to attach but the EV is put into proximity of the charging port and may be parked on a charging pad coupled to the charging port.

The charging port(s) 110 are coupled with an electric vehicle charging network server 120 (“network server”) over a communication link. The network server 120 may be coupled with the charging port(s) 110 over a Wide Area Network (WAN) such as the Internet or a Local Area Network (LAN). The network server 120 is part of an EV charging network service that provides services related to charging for the EV operators. Although the network server 120 is illustrated as a single server, it should be understood that operations performed by the network server 120 may be performed by one or more devices.

The network server 120 communicates with EV operators 145 for various reasons including establishing charging service, managing charging queue(s), and transmitting notifications regarding charging as will be described in greater detail later herein. The EV operators 145 communicate with the network server 120 using a computing device such as a laptop, desktop, tablet, smartphone, etc. The EV operators 145 may be registered with the service and may be required to provide contact information (e.g., phone number for text messages, username for instant messages, and/or email address for email messages). As will be described in greater detail later herein, the network server 120 may transmit various notifications to the operators 145 via text messages, instant messages, email messages, and/or mobile application notifications. The EV operators 145 are typically the drivers of the electric vehicles.

The charging station host(s) (“host(s)”) 150 own or control the charging port(s) 110. As will be described in greater detail herein, a host 150 may configure one or more of their charging ports as operating in community sharing mode thereby allowing EV operators to be placed in a charging queue. A host may also own or control the parking spaces associated with a charging port. Example hosts may be a corporation, a utility, a government entity, an apartment/condo owner, or other entity that owns or controls a charging port.

The community sharing and queuing manager 125 of the network server 120 allows the host(s) 150 to configure the community sharing and queuing for one or more of their charging ports; allows the EV operators to put themselves into queues configured by the host(s) 150, and manages the queues as will be described in greater detail later herein.

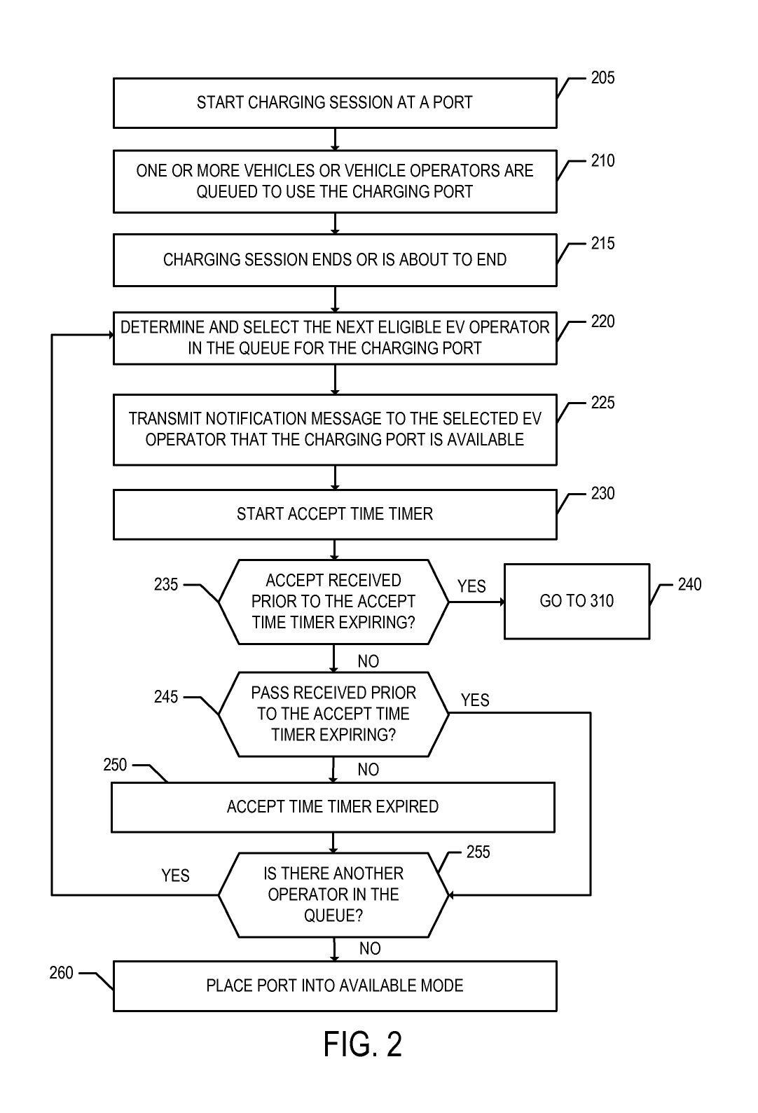

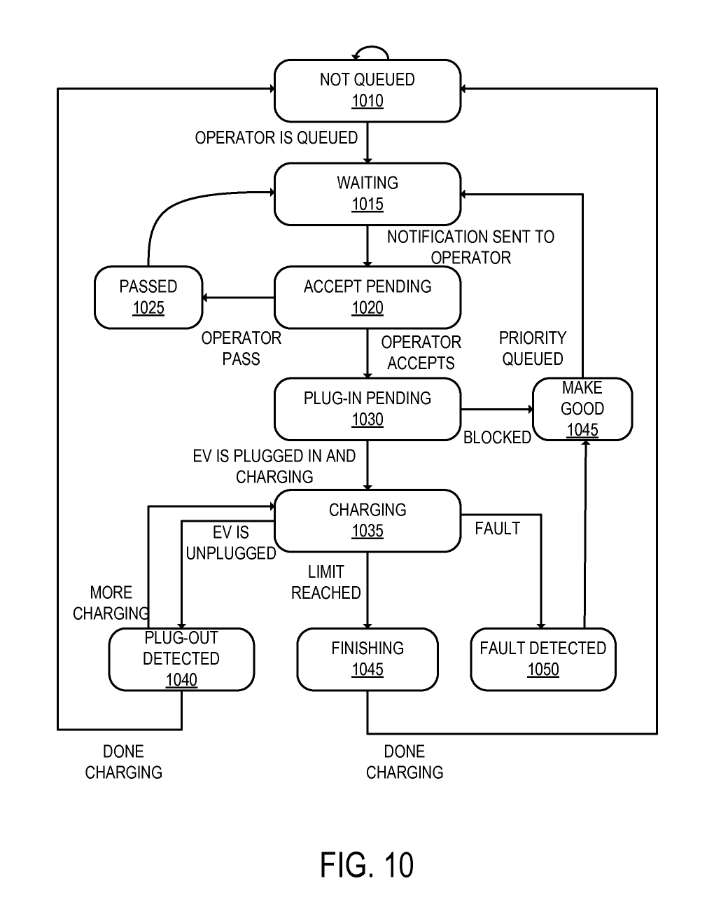

FIG. 2 is a flow diagram that illustrates exemplary operations for community sharing of one or more charging ports according to one embodiment. The operations of this and other flow diagrams will be described with reference to the exemplary embodiments of the other diagrams. However, it should be understood that the operations of the flow diagrams can be performed by embodiments of the invention other than those discussed with reference to these other diagrams, and the embodiments of the invention discussed with reference these other diagrams can perform operations different than those discussed with reference to the flow diagrams. The operations of FIG. 2 will also be described with reference to the exemplary state diagram of possible states of an EV operator account of FIG. 10.

At operation 205, a charging session is started at one of the charging port(s) 110 and energy is being transferred between an electric vehicle and the power source 115. A charging session is a time period during which energy can be transferred between an electric vehicle and a power source through a charging port. During the charging session, the electric vehicle is connected to the charging port and typically is parked in a parking space assigned or associated with the charging port. In some embodiments, there are multiple parking spaces assigned or associated with the charging port. In one embodiment, prior to the charging session being established, an authorization process was performed to determine that the EV operator was authorized to use the charging port. In one embodiment, the charging port has been configured by a charging station host to be in community sharing mode.

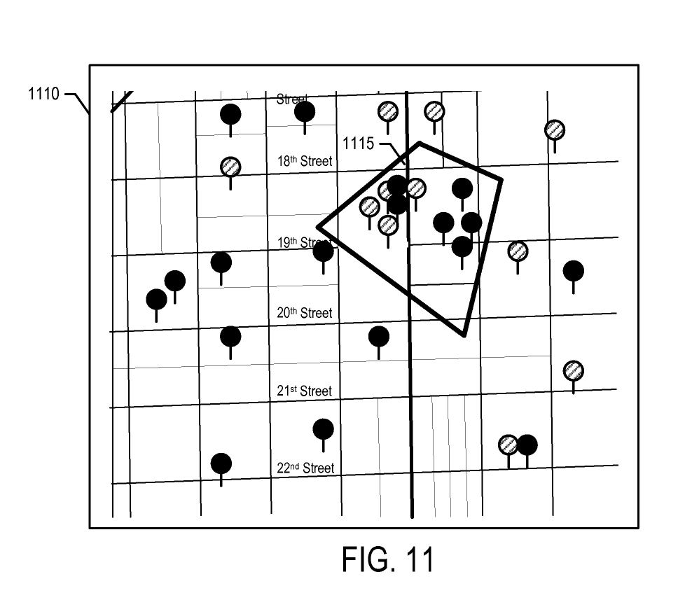

Flow moves from operation 205 to operation 210 where one or more vehicles or vehicle operators are queued to use the charging port. In one embodiment there is a single queue per charging port. In another embodiment, a single queue may be applicable for multiple charging ports. In one embodiment a vehicle operator may add themselves to a queue using a graphical user interface. For example, FIG. 11 illustrates an exemplary user interface for a vehicle operator to locate charging port(s) of interest and add themselves to one or more queues for one or more of those charging ports. The user interface 1110 illustrated in FIG. 11 allows operators to define a region of interest 1115 on the map which is a region of where they are interested in potentially queuing for charging. The user interface may allow the user to filter the charging ports including specifically including or excluding certain types of charging ports (e.g., display only level 2 ports or level 3 ports, etc.). The user interface may also allow the operators to monitor their place in the queue and may provide an estimated waiting time. In one embodiment, as part of adding themselves to a queue, an EV operator may specify a duration that they want to remain in the queue (e.g., 6 hours) or a specific time period in which they want to remain in the queue (e.g., from 3-5 PM).

In one embodiment, an EV operator may save a region of interest (with or without filter parameters) for future use. In addition, the service may allow the EV operator to create a recurring queue request such that the same request is submitted automatically and periodically (e.g., once every weekday morning). To prevent the same order from occurring, the service may employ a randomizer to create a random queue order for EV operators requesting to be queued at the same time repeatedly.

While embodiments have been described with respect to using a graphical user interface to add an EV operator to a queue, EV operators can be added to a queue differently in different embodiments. For example, an EV operator may request to be added to a queue at the charging station itself by presenting access credentials to the charging station and/or using an interface of the charging station. As another example, an EV operator may present access credentials to another device that automatically adds the EV operator to all of the queues of a defined group of charging ports. To illustrate, a business may have several charging ports onsite and may allow its guests or employees to present user credentials (e.g., to waive an RFID card near a scanner in the lobby or other location) to automatically cause that EV operator to be added to the queues of those charging ports. The EV operator may also specify notification configuration information such as notification options for that EV (e.g., a number for text messages, a username for instant messaging, an email address, etc.).

In one embodiment the service only allows an EV operator to queue to a particular charging port if they are within a predefined distance of that charging port. For example, the network server 120 may request the GPS location of a mobile device of the EV operator and/or the GPS location of an EV of the EV operator and only display those charging port(s) in the user interface that are within a predefined distance (which may be configured by the host).

With reference to FIG. 10, a vehicle operator is in the not queued state 1010 until they are added to one or more queues. The vehicle operator moves from the not queued state 1010 to the waiting state 1015 when they are queued and waiting for one or more charging ports to become available.

Referring back to FIG. 2, flow moves from operation 210 to operation 215 where the current charging session at the charging port ends or is about to end. In one embodiment the host configures each charging session to last only until a certain limit has been reached such as the EV being fully charged, the EV reaching a predefined state-of-charge, a maximum time limit (e.g., 1 hour), a maximum amount of energy transferred, or a combination. The limit may be defined by the host to be different for different charging ports and/or for different EV operators. In one embodiment the charging station that includes the charging port may determine whether the limit has been reached. In another embodiment the network server 120 determines whether the limit has been reached. The charging session may also end if the vehicle operator disconnects the electric vehicle from the charging port. Flow then moves to operation 220.

At operation 220, the network server 120 determines and selects the next eligible EV operator in the queue for the charging port. In one embodiment, the queue is a first in first out (FIFO) queue where every EV operator has equal priority (at least initially). As will be described in greater detail later herein, if an EV operator experiences a fault with a charging station or charging port that prevents them from charging or is blocked by another vehicle, that EV operator may be granted priority over other EV operators in the queue.

In one embodiment, a set of EV operator(s) may have priority in the queues that differs from that of other EV operators based on their status. For example, executives of a company may have priority in the queues over employees; EV operators using EVs for company or business use (e.g., maintenance vehicles) may have priority over EV operators using EVs for personal use; EV operators using battery only EVs (BEVs) may have priority over EV operators using plug-in hybrid electric vehicles (PHEVs); EV operators that are members of a loyalty program of the host that owns or controls the charging port may have priority over other non-members; or any combination of the above. In one embodiment, an EV operator may receive priority in queuing by paying a premium for the charging service versus other EV operators.

In one embodiment, determining the next eligible EV operator in the queue for the charging port includes searching the queue front to back to find the next eligible EV operator in one of the following states and in the following order: EV operators whose state is “make-good” (that EV operator may have already been queued and selected and experienced a fault with a charging station and/or charging port that prevented them from charging), an EV operator whose state is “passed” (that EV operator may have already been queued and passed on using a charging port); and EV operators whose state is “waiting”. The states will be described in more detail with respect to FIG. 10. In each of those three states, different EV operators may have different priority over other EV operators.

In one embodiment, determining the next eligible EV operator in the queue takes into consideration the location of the EV operator at the time of the decision. For example, the network server 120 may request the GPS location of a mobile device of the EV operators to determine the locations of the EV operators and/or request the GPS location of the EVs of the EV operators. By way of example if the determined location of an EV operator and/or their EV is farther than a predefined limit (which may be configured by the host), the network server 120 may not select that EV operator (instead that EV operator may be treated as implicitly passing). This helps avoid the scenario of transmitting a charging port available notification message to an EV operator that is physically too far away to connect their EV to the charging port in a timely fashion.

In one embodiment, an EV operator may be subject to a personal maximum amount of time charging per unit of time (e.g., day, week, pay period, month, etc.) for a particular charging port or for a group of one or more charging ports (e.g., all of the charging ports of a particular host) and/or subject to a personal maximum amount of energy transferred per unit of time (e.g., day, week, pay period, month, etc.) for a particular charging port or for a group of one or more charging ports. In such an embodiment, determining the next eligible EV operator in the queue considers whether the EV operator is over or near the personal maximum amount of time charging and/or whether the EV operator is over or near the personal maximum amount of energy transferred. An EV operator that is over or near one of these personal maximum limits may be skipped in favor of an EV operator that is not over their personal maximum limit. An EV operator may also be removed from the queue and/or not accepted into the queue if the EV operator is over a personal maximum of time charging and/or personal maximum of amount of energy transferred. The personal maximum amount of time of charging and/or the personal maximum amount of energy transferred may be configured by the host.

After determining and selecting the next eligible EV operator, flow moves to operation 225 where the network server 120 transmits a notification message to that selected EV operator that notifies the EV operator that the charging port is available. This message is sometimes referred to herein as a charging port available notification message. The notification message may be a text message, an instant message, an email message, and/or a mobile application notification message for example. In one embodiment the charging port available notification message includes a way for the EV operator to accept use of the charging port, which provides his intention to use the charging port and/or a way for the EV operator to pass on using the charging port, which provides his intention to not use the charging port. For example an email message may be transmitted to the EV operator where the message includes one or more buttons that allow the EV operator to accept or pass. The notification message may include a link to a locator map (e.g., a similar user interface as illustrated in FIG. 11) with the port automatically selected. The notification message may also indicate a time limit in which the EV operator has to respond before moving on to the next EV operator in the queue. Flow moves from operation 225 to operation 230. With respect to FIG. 10, the EV operator moves from the waiting state 1015 to the accept pending state 1020 after the charging port available notification message is sent to the EV operator. A notification message may also be sent to the EV operator whose charging session has ended. This notification message may instruct that EV operator to move their vehicle. In embodiments where there are multiple parking spaces assigned or associated with the charging port, this notification message may notify that EV operator that another EV operator has been given authorization to disconnect their EV from the charging port.

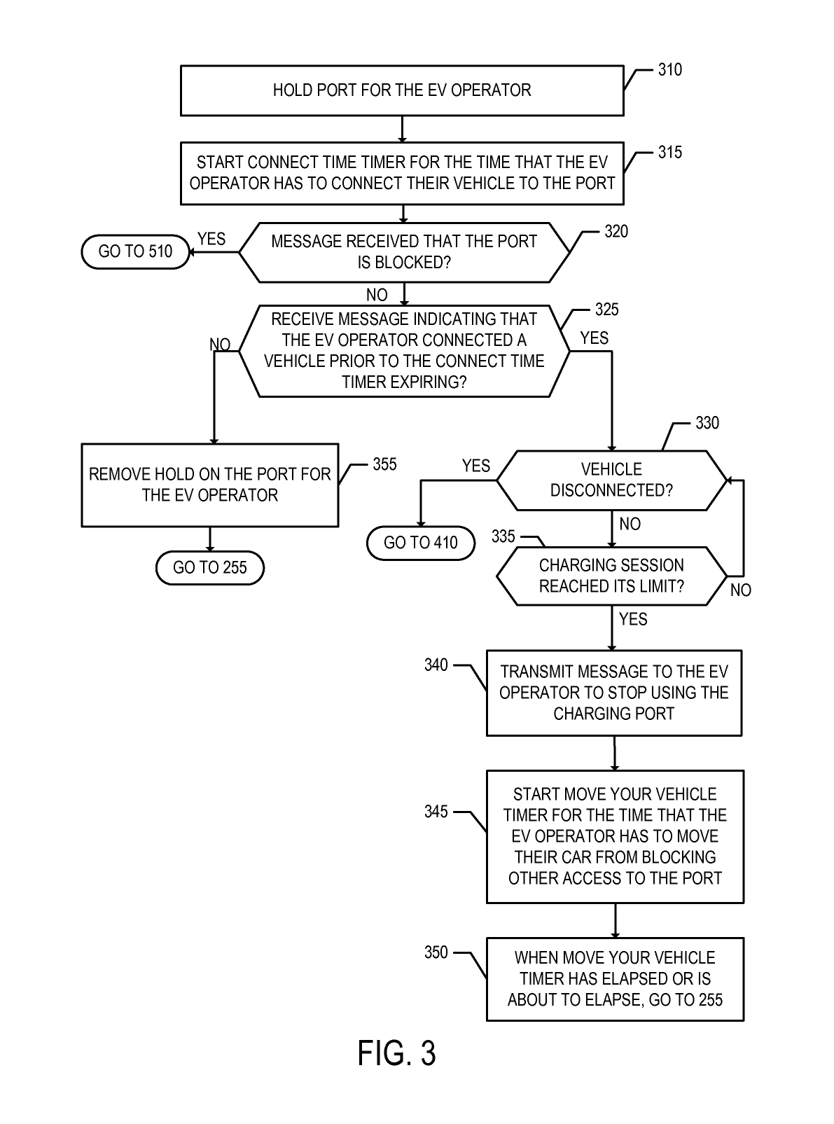

At operation 230, the network server 120 starts an accept time timer for the EV operator. The accept time timer is a time period in which the EV operator has to accept or pass upon being notified that the charging port is available. The accept time timer may be a host-configured timer or may be a default value. In one embodiment, if the accept time timer expires with no EV operator action, then the network server 120 treats this as an implicit pass and moves on to the next EV operator in the queue (if any). Flow moves from operation 230 to operation 235 where the network server 120 determines whether an accept message has been received from the EV operator prior to the accept time timer expiring. If it has, then flow moves to operation 310 which will be described with reference to FIG. 3. If an accept message has not been received, then flow moves to operation 245 where it is determined whether a pass message has been received from the EV operator prior to the accept time timer expiring. If it has, then flow moves to operation 255. If neither an accept message nor a pass message has been received prior to the accept time timer expired, then flow moves from operation 250 (the accept time timer has expired) to operation 255. In one embodiment, instead of transmitting an accept message, an EV operator may connect their EV to the charging port which is treated by the network server 120 as an acceptance.

With reference to FIG. 10, the EV operator moves from the accept pending state 1020 to the passed state 1025 either upon an explicit pass (e.g., explicitly sending a message indicating their intention to pass on charging) or an implicit pass (e.g., not responding to the charging port available notification message). The EV operator moves from the accept pending state 1020 to the plug-in pending 1030 upon accepting the charging port available notification message. In the plug-in pending state, the EV operator is expected to connect an EV to the charging port within a specified time (which may be configured by the host or set by default).

In one embodiment, if an EV operator passes on the use of a charging port either explicitly (e.g., transmitting a message that indicates their intention to pass) or implicitly (not responding to the charging port available notification message), that EV operator will not receive another charging port available notification message for at least a period of time. For example, a pass-skip time timer may be started by the network server 120 (which may be configurable by the host) which corresponds with the minimum time that must elapse after an EV operator has passed (either explicitly or implicitly) before they will be offered a subsequent available charging port. This is done because if the EV operator was not available to accept the use of a charging port (e.g., the EV operator could not physically move their vehicle and/or connect their vehicle to the charging port at that time) they will be unlikely to accept the use of that charging port or another charging port relatively quickly after the first pass.

In one embodiment, the service maintains a maximum consecutive pass count for the EV operators such that if an EV operator exceeds that maximum consecutive pass count the service will remove the EV operator from all queues or move to the end of the queues with the conclusion being that the EV operator is either too busy or no longer interested in charging a vehicle. The maximum consecutive pass count may be configurable by the host.

In one embodiment, if an EV operator passes on the use of a charging port either explicitly or implicitly in embodiments where there are multiple parking spaces assigned or associated with that charging port, that EV operator will be removed from the queue and a notification message will be transmitted to that EV operator that instructs the EV operator to move their vehicle so that it is not blocking another EV operator that may wish to use the charging port.

At operation 255, it is determined whether there is another EV operator in the queue for the charging port. If there is not another EV operator in the queue, then flow moves to operation 260 and the charging port is placed into an available mode where any authorized operators may use the charging port. If there is another EV operator in the queue, then flow moves back to operation 220.

With reference to FIG. 3, at operation 310 a hold on the charging port is placed for the EV operator such that only that EV operator will be able to use the charging port. In one embodiment the network server 120 transmits a hold message to the charging station that includes the charging port that instructs the charging station to only allow charging for that EV operator. The hold message may include an identifier of the EV operator or other credentials that allow the EV operator to identify themselves or the session in order to use the charging port. In another embodiment, the network server 120 creates a hold for the charging port such that a request for a charging session is received at the network server 120 (e.g., either sent by the EV operator using a computing device or sent by the charging station) where the request includes an identifier or other credentials of the EV operator and the network server 120 determines whether to grant or deny the charging session based on the include identifier or credentials. Flow moves from operation 310 to operation 315.

In one embodiment, the network server 120 transmits a message to the charging station that manages the charging port with instructions to display the name or avatar name of the EV operator for which the charging port is being held and indicate that the charging port is being held for that EV operator. In this way other EV operators that arrive to the station may quickly know that the charging port is being held for another EV operator and also serves as notification to the EV operator which charging port is being held for them.

At operation 315, a connect time timer is started. The connect time timer may be started and maintained at the network server 120 or the charging station that manages the charging port. The connect time is a time period in which the EV operator has to connect their EV once the EV operator has accepted the notification that the charging port is available. The connect time timer may be a host-configured timer or may be a default value. Flow then moves to operation 320.

In embodiments where there are multiple parking spaces assigned or associated with the charging port, the charging port may still be connected to the previous EV when the selected EV operator arrives to the charging port to connect their EV. In such embodiments, the EV operator may disconnect the EV currently connected and instead connect their EV to the charging port (e.g., unplug the previous EV and plug in their EV). The charging station may display a message that indicates when it is safe to disconnect the previous EV.

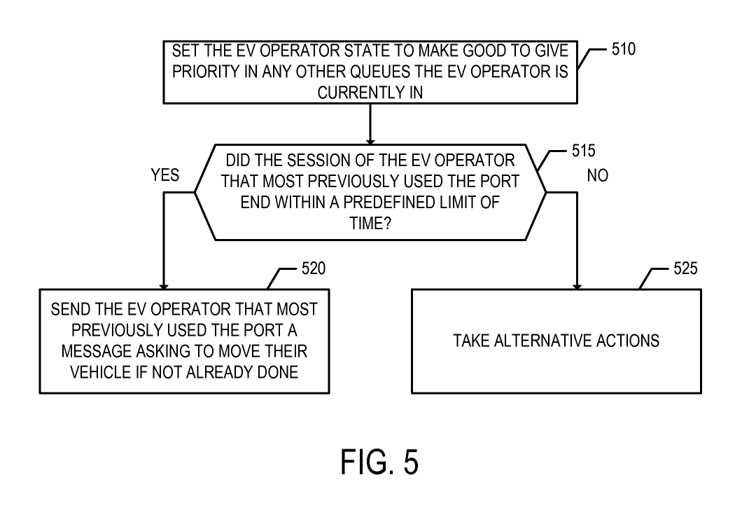

Although the charging port has been held for the EV operator, it is possible that the EV operator will not be able to physically access the charging port due to another vehicle blocking physical access to the port. For example a vehicle may be parked in the parking space(s) that are associated with the charging port. A blocking vehicle may be the previous EV that was charging or may be a completely different vehicle (EV or not). The EV operator may send a message to the network server 120 indicating that they are blocked and may give a reason why they are blocked (e.g., a vehicle, debris, etc.). The EV operator may send the message directly to the network server 120 or may use the charging station to send the message. If the network server 120 receives a message indicating that the port is blocked, then flow moves to operation 510 which will be described with reference to FIG. 5. With respect to FIG. 10, the EV operator moves from the plug-in pending state 1030 to the make good state 1045 where the service will prioritize the EV operator in other queues.

If the network server 120 does not receive a message indicating that the port is blocked, then flow moves to operation 325 where the network server 120 determines whether it has received a message indicating that the EV operator has connected an EV prior to the connect time timer expiring. By way of example, the charging station may transmit a message to the network server 120 when the EV operator has connected an EV to the charging port. The network server 120 may also periodically poll the charging station to determine whether an EV has been connected. If the network server 120 does not receive a message indicating that the EV operator connected an EV to the charging port prior to the connect time timer expiring, then flow moves to operation 355. If the network server 120 receives a message indicating that the EV operator connected an EV to the charging port prior to the connect time timer expiring, then flow moves to operation 325. With respect to FIG. 10, the EV operator moves from the plug-in pending state 1030 to the charging state 1035 upon connecting their EV and charging has commenced.

Since there is a hold on the charging port for the EV operator (only that EV operator may use the charging port), in some embodiments the EV operator connecting an EV to the charging port includes the EV operator presenting an identifier or other access credentials to the charging station that manages the charging port or through the network server to verify the identity of the EV operator.

By way of a specific example, the EV operator may waive an RFID card that includes an identifier or access credentials of the EV operator near an RFID reader of the charging station that manages the charging port. As another example the charging station may include a user interface for the EV operator to input an identifier or other access credentials. The charging station may perform a local authorization based on the received identifier or access credentials (e.g., the charging station may compare the identifier with an identifier received during the hold message). Alternatively, the charging station may transmit an authorization request to the network server with the identifier and the access credentials where the network server determines whether the EV operator is authorized to use the charging port based on the identifier or access credentials.

As another example, in some embodiments the EV operator connecting an EV to the charging port includes the EV operator submitting a request to the network server using a computing device such as a laptop, desktop, tablet, smartphone, etc. For example, an identifier of the charging port or charging station is transmitted to the network server along with an identifier or other access credentials of the EV operator. The network server determines whether the EV operator is authorized to use the identified charging port based on the identifier or access credentials of the EV operator. Upon determining that the EV operator is authorized to use the charging port, the network server transmits an authorization success message to the charging station that instructs the charging station to allow the charging session to commence.

At operation 355, the network server 120 removes the hold on the charging port for the EV operator. For example the network server 120 may transmit a message to the charging station that instructs the charging station to remove the hold for the charging port for the EV operator. Alternatively the hold may expire automatically (e.g., the hold may only be applicable for roughly the same amount of time as the connect time). Flow then moves from operation 355 back to operation 255.

In some embodiments an EV operator is allowed to stop their charging session by simply disconnecting their EV from the charging port. For example, when done charging (or whenever the EV operator desires), the EV operator can simply disconnect their EV from the charging port and may move their vehicle. This may be done without the service having prior knowledge that the EV operator will disconnect their vehicle. Although electric vehicles can be disconnected from the charging port for expected reasons, they can also be disconnected unexpectedly from the perspective of the EV operator. For example, another person may maliciously disconnect the EV before the EV was done charging (e.g., in an attempt to connect themselves to use the charging services or for other reasons). Thus in some circumstances although the service may know when an EV is disconnected, it may not know if it was the intention of the EV operator to disconnect the EV.

At operation 330, it is determined whether the EV has been disconnected from the charging port. According to one embodiment, the charging station that manages the charging port determines whether the EV has been disconnected by determining that voltage on a control pilot signal is of a certain amount. For example, if the SAE J1772 standard is used, the charging station may determine that the EV has been disconnected when voltage on the control pilot signal is 12 volts. According to another embodiment, the charging station that manages the charging port determines whether the EV has been disconnected by determining that the energy flowing through the charging port has dropped below a threshold amount over a specified period of time. As an example, if the charging station detects that the current flowing through the charging port has dropped below 0.005 Amps for a period of 5 seconds, it can be assumed that connection between the EV and the charging port has been disrupted. Regardless of how it is determined that the EV has been disconnected, the charging station may send or cause a message to be sent to the network server 120 when it detects that the EV has been disconnected from the charging port.

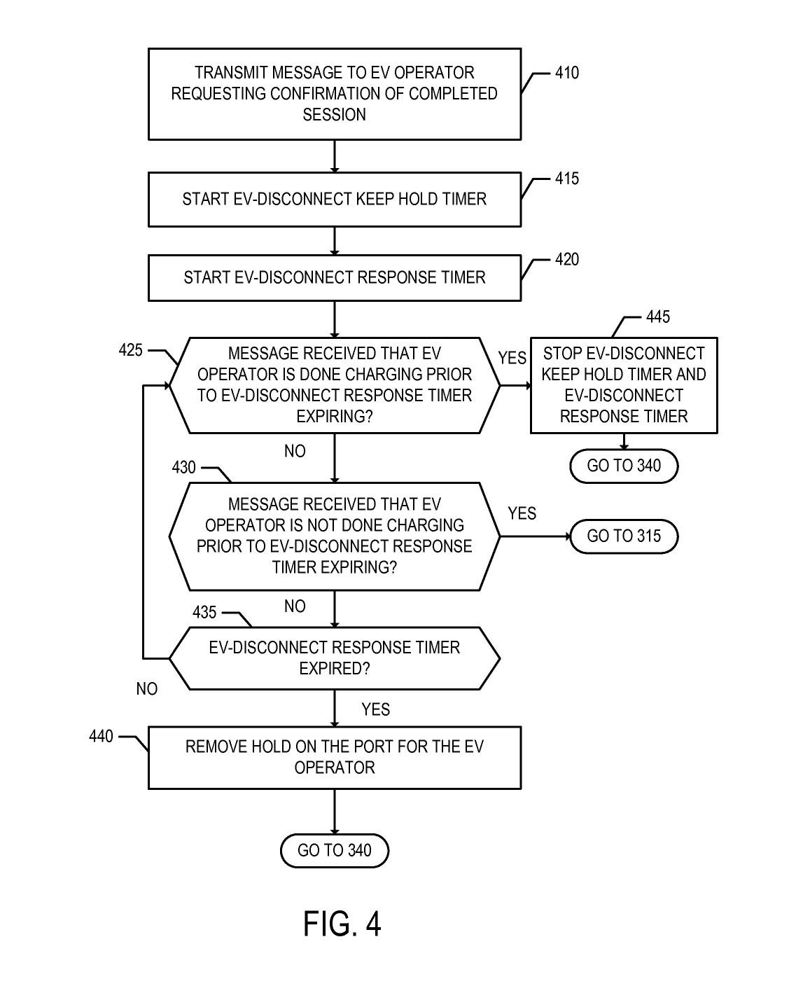

Upon determining that the vehicle has been disconnected from the charging port, then flow moves to operation 410 which will be described with respect to FIG. 4. With respect to FIG. 10, the EV operator moves from the charging state 1035 to the plug-out detected state 1040 when it is determined that the EV has been disconnected from the charging port.

If it is determined that the EV has not been disconnected from the charging port, then flow moves to operation 335 where it is determined whether the charging session has reached its limit for charging. In one embodiment, the host can configure the station such that each charging session has a charging limit while the charging port is in community mode. For example, the limit may be when the EV is fully charged, when the EV reaches a certain state-of-charge, upon reaching a maximum time limit (e.g., 1 hour), a maximum amount of energy transferred, or some combination. The limit may also be dynamic depending on the number of EV operators in the queue. For example, the limit may be relatively large if there are relatively few EV operators in the queue and relatively low if there are relatively many EV operators in the queue. If the charging session has not reached its limit, then flow moves back to operation 330, otherwise flow moves to operation 340. With respect to FIG. 10, the EV operator moves from the charging state 1035 to the finishing state 1045 when the limit has been reached. During the finishing state 1045 the EV operator will be instructed to disconnect from the charging port and in some embodiments may be instructed to move their EV.

After reaching its charging session limit, the network server 120 transmits a message to the EV operator to notify them to stop using the charging port at operation 340. The message may also instruct or remind the EV operator that they are to physically move their vehicle if their vehicle would otherwise be blocking physical access to the charging port for future EV operators. The message may also specify a time limit (which may be configurable by the host) during which they are expected to disconnect and/or move their EV. This message may be sent in a text message, an instant message, an email message, and/or a mobile application notification message, for example. Flow then moves to operation 345.

At operation 345, the network server 120 starts a move your vehicle timer which corresponds with the amount of time that the EV operator has to disconnect from the charging port and move their vehicle. The move your vehicle timer may be a host-configured timer or may be a default value. Flow then moves to operation 350 where the network server 120 moves to operation 255 when the move your vehicle timer elapses. Prior to moving to operation 255, the network server 120 may query the charging station to determine whether the vehicle has been disconnected from the charging port. If the EV has not been disconnected from the charging port, then other action may be taken instead of moving to operation 255.

In some embodiments where there are multiple parking spaces assigned or associated with the charging port, the operations 340-350 are not performed when the charging session has reached its limit. Instead, when the charging session has reached its limit, a notification message may be sent to the EV operator that notifies them that the limit has been reached and may also notify them that another EV operator (if there is another EV operator in the queue for the charging port) is allowed to disconnect that EV operator's EV from the charging port. The notification message may or may not also notify them that they are to move their EV. In such an embodiment, flow moves back to operation 255 after or in conjunction with transmitting such a message.

FIG. 4 illustrates exemplary operations performed in response to detecting that an EV has been disconnected from a charging port that is in community mode according to one embodiment. As described above, electric vehicles can be disconnected from the charging port for expected reasons and also for unexpected reasons from the perspective of the EV operator; however the service may not know whether the EV was disconnected for expected or unexpected reasons.

At operation 410, the network server 120 transmits a message to the EV operator that requests confirmation of a completed session. The message may include details of the disconnection including the time of the disconnection, the amount of time that the EV was connected, and/or the amount of energy that was delivered to the EV. The message may also instruct the EV operator that they may have been disconnected and they should go to their EV to reconnect if possible and if desired. The message may include a way for the EV operator to specify that they are done charging or that they need to continue to charge. For example an email message may be transmitted to the EV operator where the message includes one or more buttons that allow the EV operator to specify if they are done charging or want to continue to charge. The notification message may also indicate a time limit in which the EV operator has to respond before moving onto the next EV operator in the queue. Flow moves from operation 410 to operation 415.

At operation 415, the network server 120 starts an EV-disconnect keep hold timer which corresponds to the amount of time to keep the hold for the EV whenever there is a disconnection. This prevents another EV operator from maliciously being able to use the charging port by simply disconnecting the EV currently charging and connecting their own. The EV-disconnect keep hold timer may be configured by the host or may be a default value. Flow then moves to operation 420 where the network server 120 starts an EV-disconnect response timer which corresponds to the amount of time that the EV operator has to respond to the notification transmitted in operation 410. The EV-disconnect response timer may be configured by the host or may be a default value. Flow then moves to operation 425.

At operation 425, the network server 120 determines whether it has received a message from the EV operator that indicates that the EV operator is done charging prior to the EV-disconnect response timer expiring. If it has received such a message, then flow moves to operation 445 where the network server 120 stops the EV-disconnect keep hold timer and the EV-disconnect response timer and then flow moves back to operation 340. If the network server 120 has not received such a message, then flow moves to operation 430 where the network server 120 determines whether it has received a message from the EV operator that indicates that the EV operator is not done charging prior to the EV-disconnect response timer expiring. Upon receiving this message, flow moves back to operation 315. With respect to FIG. 10, the EV operator moves from the plug-out detected state 1040 to the charging state 1035 upon receiving a message from the EV operator that more charging is desired. The EV operator moves from the plug-out detected state 1040 to the not queued state 1010 upon receiving a message from the EV operator that charging is complete or not receiving a message from the EV operator after a predefined amount of time has elapsed.

If a message is not received from the EV operator in response to the notification transmitted in operation 410 and the EV-disconnect response timer expires, then flow moves from operation 435 to operation 440. At operation 440, the network server 120 removes the hold on the charging port for the EV operator. For example the network server 120 may transmit a message to the charging station that instructs the charging station to remove the hold for the charging port for the EV operator. Flow then moves from operation 440 back to operation 340.

In embodiments where there are multiple parking spaces assigned or associated with the charging port, instead of operation flow moving from operations 440 and 445 to operation 340, flow moves from operation flow moves from operations 440 and 445 to transmitting a notification message to the EV operator that notifies them that their charging session is over and may also notify them that another EV operator (if there is another EV operator in the queue for the charging pot) is allowed to disconnect their EV from the charging port. The notification message may or may not also notify them that they are to move their EV. In such an embodiment, flow moves back to operation 255 after or in conjunction with transmitting such a message.

As previously described, even though a charging port may be held for an EV operator such that only that EV operator may use the charging port, it is possible that the EV operator will not be able to physically access the charging port due to another vehicle blocking physical access to the charging port. FIG. 5 is a flow diagram that illustrates exemplary operations for responding to a message from an EV operator whose turn it is to use a charging port that the port is unavailable according to one embodiment (e.g., due to other vehicle(s) blocking access to the charging port by parking in the parking space(s) assigned or associated with the charging port). At operation 510, the network server 120 sets the EV operator state to make-good to give priority to the EV operator in any other charging queues that the EV operator is currently in. For example, the EV operator may be moved to the front of all other EV operators of all queues he is in except for those EV operators whose state is also make-good. To say it another way, the EV operator is placed in front of EV operators that have not experienced a block or failure but behind those other EV operators that have experienced similar problems earlier than he did. In one embodiment, if the EV operator is not in any other queues, the service may recommend one or more other charging ports for the EV operator and allow the EV operator to gain priority in those queues. With respect to FIG. 10, the EV operator is moved from the make good state 1045 to the waiting state 1015 after their priority in the queue(s) has been updated. Flow then moves to operation 515.

At operation 515, the network server 120 determines whether the session of the EV operator 515 that most previously used the port ended within a predefined limit of time (which may be configurable by the host). If it is, then flow moves to operation 520, otherwise flow moves to operation 525. At operation 520 the network server 120 transmits a message to the EV operator that most previously used the port a message asking them to move their electric vehicle if not already done. At operation 525 other actions are taken (e.g., calling a towing company to remove the vehicle).

An EV operator that does not move their vehicle and is blocking other access may be penalized by the service and/or may incur additional fees associated with using the charging port and/or parking at a parking space assigned to or associated with the charging port. By way of an example, a violating EV operator may incur one or more of the following penalties: the violating EV operator may be fined; the violating EV operator may receive lower priority in queuing for a certain period of time; charging privileges for the violating EV operator may be revoked for a period of time; and the violating EV operator may be required to pay more for charging services in the future for a period of time. Violations may also be logged such that the host can view the violating EV operators. It should be understood that these are example penalties and a violating EV operator may be subject to additional or different penalties. An EV operator whose EV is blocking access to the charging port may also be subject to having their EV towed.

A charging port that has been determined to be blocked may be taken out of the available pool of ports until it has been determined that is no longer blocked. Similarly, a charging port that is experiencing a fault may be taken out of the available pool of ports until it is determined that the fault no longer exists. A notification message may be transmitted to any EV operators that are in the queue for a charging port that is blocked or is experiencing a fault that alerts them that the charging port is not available and may also provide the reason that it is not available (e.g., due to blocking or due to a fault). When the block or fault is cleared, a notification may be transmitted to any EV operators in the queue for that charging port that the block or fault has now been cleared.

Some embodiments allow EV operators to request the EV operator currently charging to switch positions and/or request an EV operator to swap positions in the queue.

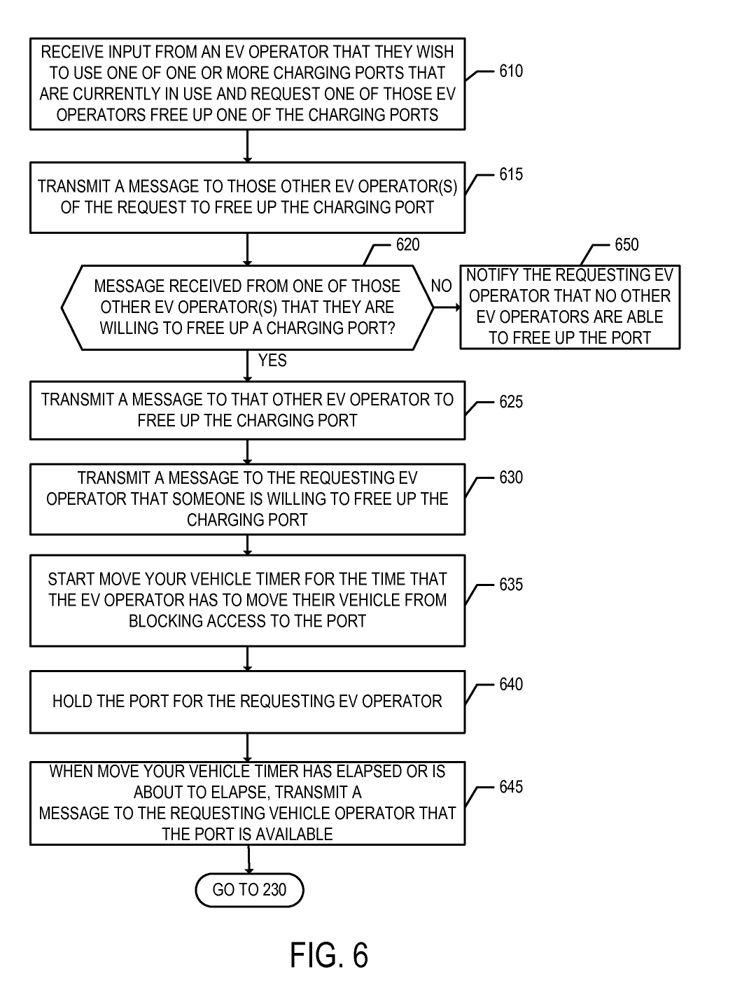

FIG. 6 is a flow diagram illustrating exemplary operations for an EV operator to request an EV operator who is currently charging to free up a charging port so that the requesting EV operator can use the charging port according to one embodiment. In one embodiment the messaging for using this feature is done anonymously through the service.

At operation 610, the network server 120 receives input from an EV operator that the EV operator wishes to use one or more charging ports that are currently in use and requests for one of those EV operators to free up one of the charging ports. The input received from the EV operator may include reasons as to why they need access to the port now and cannot wait his or her turn. In one embodiment, the EV operator uses a user interface similar to the interface of FIG. 11 to select one or more charging ports and provide a reason why they need to use one of those charging ports. The user interface may indicate that this feature should be used sparingly. In one embodiment, the network server 120 tracks how many times a particular EV operator uses this feature and may limit the number of requests received from a particular EV operator for a given period of time (e.g., weekly, monthly, etc.). The limit may be configured by the host or may be a default value. Flow moves from operation 610 to operation 615.

At operation 615, the network server 120 transmits a message to those other EV operator(s) of the request to free up the charging port. The message may include the reason of the requesting EV operator why he or she needs access to the charging port and cannot wait their turn. In one embodiment EV operators can opt-out of receiving such messages or can rate-limit the number of these messages received during a given time period (e.g., weekly, monthly, etc.). In one embodiment EV operators can add a list of other EV operators that they do not want to receive such messages from (e.g., a blacklist of EV operators) and/or a list of EV operators that they are willing to receive such messages from (e.g., a whitelist of EV operators). The EV operators may also configure their preferences such that they will not receive such messages until their charging session has been occurring for at least a certain amount of time, until at least a certain amount of energy has been transferred to their vehicle, until at least a certain amount of range is estimated for their EV, and/or until a certain percent amount of charge for their EV has occurred. In such an embodiment, the network server 120 only transmits the request message to those EV operator(s) that are configured to receive such a message. The message may be transmitted through a text message, an instant message, an email message, and/or a mobile application notification message for example. The message may include a way for the EV operator to accept or deny the request. For example an email message may be transmitted to the EV operator where the message includes one or more buttons that allow the EV operator to specify that they are accepting or denying the request. In one embodiment, the message may include the current charging status for the EV such as how long their EV has been connected, how much energy has been transferred (e.g., in kWh), and roughly how much range a typical EV would have given how much energy has been transferred. Flow moves from operation 615 to operation 620.

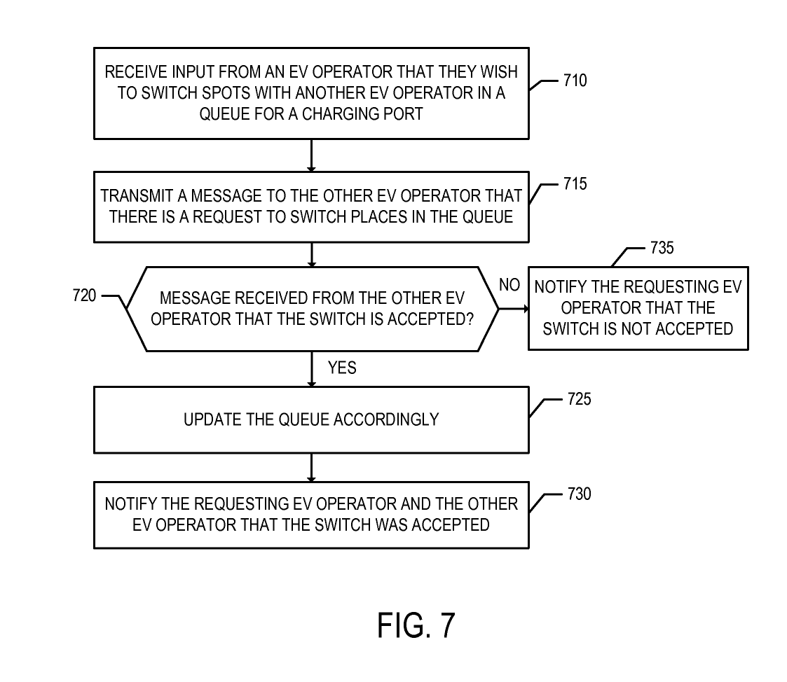

At operation 620, the network server 120 determines whether it has received a message from one of those other EV operator(s) accepting the request to free up the charging port they are currently using. If no EV operator accepts the request, then flow moves to operation 650 where the network server 120 transmits a message to the requesting EV operator that no other EV operators accepted their request. This message may also include an option for the EV operator to request the next EV operator(s) in the queue(s) if they would be willing to switch places in the queue. Switching places in the queue will be described in more detail with respect to FIG. 7.

The message may also include a rating of the EV operator making the request where the rating is based on the EV operator's actions in the community. The rating of an EV operator may be automatically determined by the service with or without input from other EV operators. For example, the rating of the EV operator may be positively benefited by previous actions such as agreeing to switch places in the queue with other EV operators or allowing other EV operators to charge ahead of them. The rating of the EV operator may be negatively affected by various actions including failing to appear at a charging port that has been held for them (e.g., accepting the use of a charging port but not actually using the charging port), failing to move their EV in a timely fashion after their charging session has completed, a number of passes that exceeds a predefined limit, a number of complaints received from other EV operators, and/or the number of times they make special requests such as switching places in the queue or a request for immediate charging. The rating may help the EV operator in determining whether to accept the request.

In some embodiments the requesting EV operator may also make an offer with a monetary or other reward for acceptance, which may be communicated in the message to the other EV operators that are currently charging.

If at least one EV operator accepts the request, then flow moves from operation 620 to operation 625. In some embodiments the rating for the EV operator that accepts the request will be improved due to accepting the request. An EV operator that accepts or denies the request may also submit a rating (e.g., a complaint) regarding the requesting EV operator.

At operation 625, the network server 120 transmits a message to that other EV operator that accepted the request with instructions to free up the charging port (e.g., disconnect from the charging port and move their EV). This message may be sent in a text message, an instant message, an email message, and/or via a mobile application notification. The message may also specify a time limit (which may be configurable by the host) during which they are expected to disconnect and/or move their EV. Flow then moves to operation 630.

At operation 630, the network server 120 transmits a message to the requesting EV operator that an EV operator is accepting the request and is willing to free up the charging port. The message may indicate the estimated time that the charging station will be available. The message may also instruct the EV operator that they will receive another message alerting him or her when the charging port becomes available. Flow then moves to operation 630.

At operation 635, the network server 120 starts a move your vehicle timer which corresponds with the amount of time that the EV operator has to disconnect from the charging port and/or move their vehicle. The move your vehicle timer may be a host-configured timer or may be a default value.

Flow moves from operation 635 to operation 640 where the network server 120 causes a hold to be placed on the charging port for the requesting EV operator. The hold may not start until the accepting EV operator finishes their charging session (e.g., by disconnecting their EV from the charging port). Flow then moves to operation 645.

At operation 645, when the move your vehicle timer has elapsed or is about to elapse, the network server 120 transmits a message to the requesting vehicle operator that the port is now available. This message may be similar to the message transmitted in operation 225. Flow then moves to operation 230.

FIG. 7 is a flow diagram illustrating exemplary operations for an EV operator to request another queued EV operator to swap positions in the queue according to one embodiment. In one embodiment the messaging is done anonymously through the service. At operation 710, the network server 120 receives input from an EV operator that the EV operator would like to switch spots with another EV operator in a queue for a charging port. The input may include specifically which spot in the queue the EV operator would like to switch spots with. The input may also include a group of places that the EV operator would like to switch spots with. The input received from the EV operator may include a reason why the switch is requested. In one embodiment, the EV operator uses a user interface similar to the interface of FIG. 11 to select one or more charging ports and provide a reason why they would like to switch spots in the queue. The user interface may indicate that this feature should be used sparingly. In one embodiment, the network server 120 tracks how many times a particular EV operator uses this feature and may limit the number of requests received from a particular EV operator for a given period of time (e.g., weekly, monthly, etc.). The limit may be configured by the host or may be a default value. Flow moves from operation 710 to operation 715.

At operation 715, the network server 120 transmits a message to that EV operator that holds the place in the queue that is wanted by the requesting EV operator that indicates the request to switch places in the queue. The message may specifically include the spot in the queue that the requesting EV operator is currently in. The message may include the reason the requesting EV operator would like to switch spots in the queue. In one embodiment EV operators can opt-out of receiving such messages or can rate-limit the number of these messages received during a given time period (e.g., weekly, monthly, etc.). In one embodiment EV operators can add a list of other EV operators that they do not want to receive such messages from (e.g., a blacklist of EV operators) and/or a list of EV operators that they are willing to receive such messages from (e.g., a whitelist of EV operators). In such an embodiment, the network server 120 only transmits the request message to those EV operator(s) that are configured to receive such a message. The message may be transmitted through a text message, an instant message, an email message, and/or via a mobile application notification for example. The message may include a way for the EV operator to accept or deny the request. For example an email message may be transmitted to the EV operator where the message includes one or more buttons that allow the EV operator to specify that they are accepting or denying the request. Flow moves from operation 715 to operation 720.

At operation 720, the network server 120 determines whether it has received a message from the other EV operator accepting the request. If the message is not accepted, then flow moves to operation 735 where the network server 120 transmits a message to the requesting EV operator that the request for the position swap was not accepted. This message may also include an option for the EV operator to request the next EV operator(s) in the queue(s) if they would be willing to switch places in the queue. If a message accepting the request is received from the other EV operator, then flow moves from operation 720 to operation 725.

At operation 725, the network server 120 updates the queue accordingly to reflect the queue position switch. Flow then moves to operation 730 where the network server 120 transmits a message to the requesting EV operator and the other EV operator that the switch was accepted. The message to each respective one of these EV operators may include the specific place in the queue that respective EV operator is now located after the switch. The message may be a text message, an instant message, an email message, and/or a mobile application notification for example.

In one embodiment, the network server 120 prevents an EV operator that requests a queue position swap that is accepted from making a subsequent queue position swap until that EV operator is back in the not queued state and re-queues at a later time.

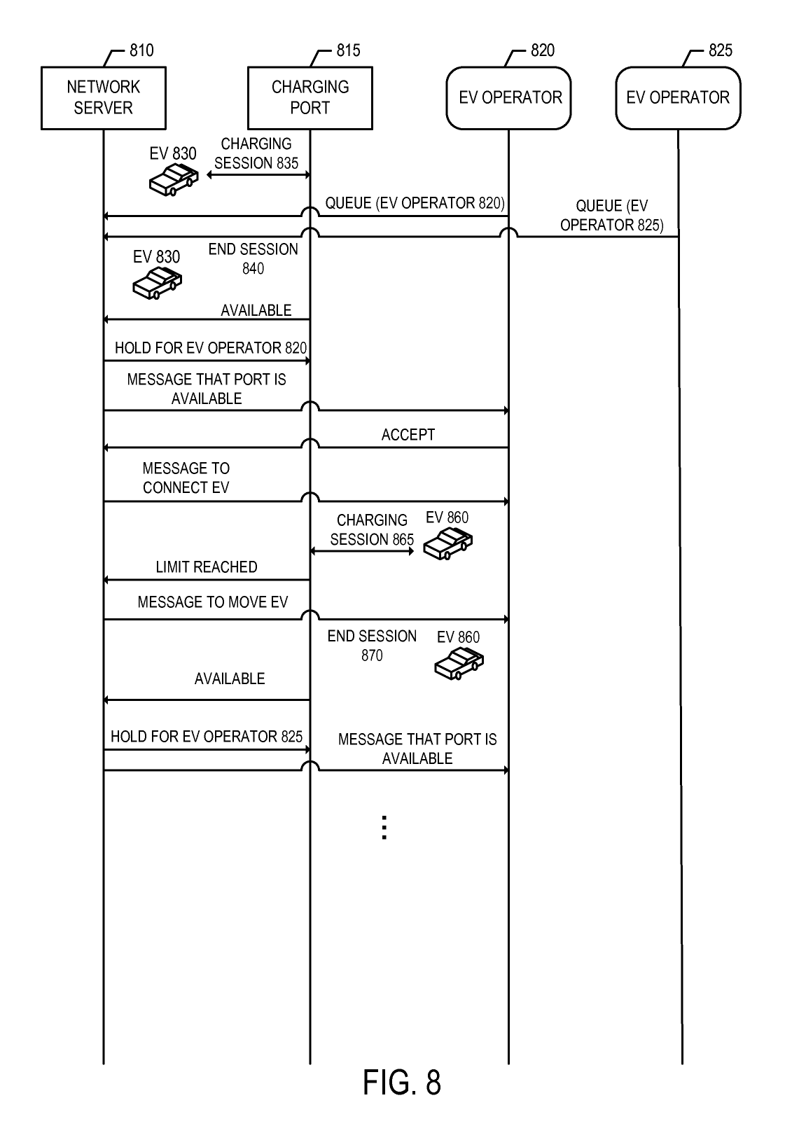

FIG. 8 is a system diagram illustrating exemplary operations performed for multiple EV operators are waiting in a queue for access to a charging port according to one embodiment. As illustrated in FIG. 8, initially a charging session 835 exists between the EV 830 and the charging port 815. The EV operator 820 uses the network server 810 to add himself to the queue for the charging port 815. The EV operator 820 is in the front of the queue (that is, the EV operator 820 is queued to next use the charging port 815 after the charging session 835 is complete). The EV operator 825 uses the network server 810 to add himself to the queue for the charging port 815. The EV operator 825 is in the queue after the EV operator 820.

After the charging session 835 ends in operation 840, a message is sent to the network server 810 that the charging port 815 is available. This message may be sent by the charging station that manages the charging port 815. In one embodiment, this message is not transmitted until detecting that the EV 830 has been moved from the parking space assigned or associated with the charging port 815. For example, the charging port, the charging station that manages the charging port, or another device may detect the presence of a vehicle occupying the parking space assigned to or associated with the charging port 815. For example a sonar sensor array, a camera, or an induction coil may be used to detect the presence of a vehicle. The sonar sensor array may be attached to the charging port or charging station or to another structure in close proximity to the charging port that is capable of detecting proximity of an object such as a vehicle. A camera may provide a signal to the charging station or the network server 810 which includes an object recognition program to detect the presence of a vehicle or other obstruction. An induction coil may be embedded in the pavement of the parking space or is protected by a roadworthy casing attached to the surface of the pavement of the parking space and connected to the charging port or charging station and detects the presence of large metal objects in close proximity to the coil such as objects of a vehicle.

The network server 810 receives the message and places a hold on the charging port 815 for the EV operator 820. For example, the network server 810 transmits a message to the charging station that manages the charging port 815 that indicates that only the EV operator 820 is allowed to use the charging port 815. In one embodiment, the message includes an identifier or other credentials of the EV operator 820 that the EV operator 820 must present when connecting to the charging port 815 in order to use the charging port 815.

The network server 810 also transmits a message to the EV operator 820 that the charging port 815 is available. The message may be similar to the message described with reference to operation 225 of FIG. 2. The EV operator 820 may accept the use of the charging port 815, pass on using the charging port 815, or may not respond to the message. In conjunction with transmitting this message, the network server may also start a timer during which the EV operator 820 must respond or else it will be assumed that the EV operator is passing on using the charging port 815. As illustrated in FIG. 8, the EV operator 820 has accepted the use of the charging port 815 and transmitted a message to the network server 810 indicating as such.

The network server 810 receives the message from the EV operator 820 accepting use of the charging port 815 and transmits a message to the EV operator 820 with instructions to connect their EV to the charging port 815. The network server 810 may also start a timer during which the EV operator 820 must connect their EV to the charging port 815 or else be treated as a failure to show. As illustrated in FIG. 8, the EV operator 820 has connected their EV 860 to the charging port 815 and the charging session 865 has commenced.

At some point the charging session 865 will end. In one embodiment the host of the charging port 815 can configure the charging sessions to last until reaching a limit such as when the EV is fully charged, upon reaching a maximum time limit, upon reaching a maximum amount of energy transferred, upon reaching a certain state-of-charge, or some combination. The EV operator 820 may also end the charging session 865 voluntarily prior to reaching any defined limit. For example, the EV operator 820 may simply disconnect the EV 860 from the charging port 815 to stop the charging session 865.

For the example illustrated in FIG. 8, a limit has been reached and reported to the network server 810. A message reporting that the limit has been reached may be sent by the charging station that manages the charging port 815. After receiving the message, the network server 810 transmits a message to the EV operator 820 indicating that the limit has been reached and the EV should be disconnected from the charging port 815 and moved so as to not block access for future vehicles. This message may be similar to the message described with respect to operation 340 of FIG. 3. The network server 810 may also start a timer during which the EV operator must disconnect from the charging port 815 or else may be treated as a failure to move. In the example illustrated in FIG. 8, the EV 860 has been disconnected from the charging port 815 and the session has ended 870.

After the EV 860 has been disconnected from the charging port 815, a message is sent to the network server 810 that indicates that the charging port 815 is available. This message may be transmitted by the charging station that manages the charging port 815. In one embodiment, this message is not transmitted until detecting that the EV 860 has been moved from the parking space assigned or associated with the charging port 815.

The network server 810 receives the message that the charging port 815 is available and searches the queue for the charging port 815 to determine if there is another EV operator in the queue. In the example illustrated in FIG. 8, the EV operator 825 is next up to use the charging port 815. As a result, the network server 810 places a hold on the charging port 815 for the EV operator 825 and transmits a message to the EV operator 825 that the charging port 815 is available. The operations continue like they did for the EV operator 820.

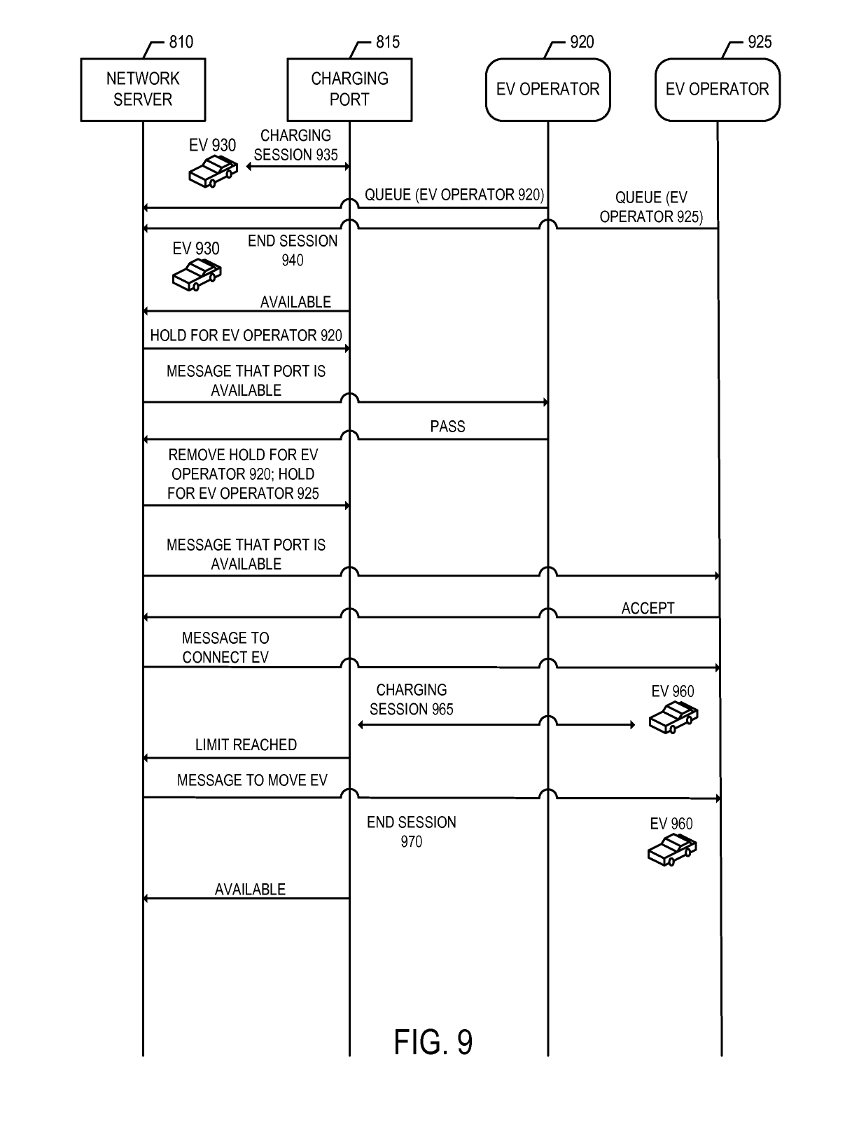

FIG. 9 is a system diagram illustrating exemplary operations performed for multiple EV operators are waiting in a queue for access to a charging port according to one embodiment. Unlike the example of FIG. 8, FIG. 9 illustrates operations when an EV operator passes on the use of a charging port. As illustrated in FIG. 9, initially a charging session 935 exists between the EV 930 and the charging port 815. The EV operator 920 uses the network server 810 to add himself to the queue for the charging port 815. The EV operator 920 is in the front of the queue (that is, the EV operator 920 is queued to next use the charging port 815 after the charging session 935 is complete). The EV operator 925 uses the network server 810 to add himself to the queue for the charging port 815. The EV operator 925 is in the queue after the EV operator 920.

After the charging session 935 ends in operation 940, a message is sent to the network server 810 that the charging port 815 is available. This message may be sent by the charging station that manages the charging port 815. In one embodiment, this message is not transmitted until detecting that the EV 930 has been moved from the parking space assigned or associated with the charging port 815 as similar described with respect to FIG. 8.

The network server 810 receives the message and places a hold on the charging port 815 for the EV operator 920. For example, the network server 810 transmits a message to the charging station managing the charging port 815 that indicates that only the EV operator 920 is allowed to use the charging port 815. In one embodiment, the message includes an identifier or other credentials of the EV operator 920 that the EV operator 920 must present when connecting to the charging port 815 in order to use the charging port 815.

The network server 810 also transmits a message to the EV operator 920 that the charging port 815 is available. The message may be similar to the message described with reference to operation 225 of FIG. 2. As illustrated in FIG. 9, the EV operator 920 has passed on using the charging port 815 and transmitted a message to the network server 810 indicating as such.

The network server 810 receives the message from the EV operator 920 passing on the use of the charging port 815. The network server 810 searches the queue for the charging port 815 and determines that the EV operator 925 is next up to use the charging port 815. The network server 810 removes the hold on the charging port 815 for the EV operator 920 and places a hold on the charging port 815 for the EV operator 925. For example, the network server 810 transmits a message to the charging station managing the charging port 815 that instructs the charging station to allow only the EV operator 925 to use the charging port 815.

The network server 810 also transmits a message to the EV operator 925 that the charging port 815 is available. The message may be similar to the message described with reference to operation 225 of FIG. 2. As illustrated in FIG. 9, the EV operator 925 has accepted the use of the charging port 815 and transmitted a message to the network server 810 indicating as such.

The network server 810 receives the message from the EV operator 925 accepting use of the charging port 815 and transmits a message to the EV operator 925 with instructions to connect their EV to the charging port 815. The network server 810 may also start a timer during which the EV operator 925 must connect their EV to the charging port 815 or else be treated as a failure to show. As illustrated in FIG. 9, the EV operator 925 has connected their EV 960 to the charging port 815 and the charging session 815 has commenced.

At some point the charging session 965 will end. As illustrated in FIG. 9, a limit has been reached on the charging session 965 and has been reported to the network server 810. A message reporting that the limit has been reached may be sent by the charging station that manages the charging port 815. After receiving the message, the network server 810 transmits a message to the EV operator 925 indicating that the limit has been reached and the EV should be disconnected from the charging port 815 and moved so as to not block access for future vehicles. This message may be similar to the message described with respect to operation 340 of FIG. 3. The network server 810 may also start a timer during which the EV operator must disconnect from the charging port 815 or else may be treated as a failure to move. In the example illustrated in FIG. 9, the EV 960 has been disconnected from the charging port 815 and the session has ended 970.

After the EV 960 has been disconnected from the charging port 815, a message is sent to the network server 810 that indicates that the charging port 815 is available. This message may be transmitted by the charging station that manages the charging port 815. In one embodiment, this message is not transmitted until detecting that the EV 860 has been moved from the parking space assigned or associated with the charging port 815.

FIGS. 6 and 7 describe exemplary embodiments for EV operators to request a change in queue placement (either start charging immediately or swapping positions in the queue) where the messaging occurs through the service. In other embodiments the messaging may occur directly between the EV operators.

There are several ways that EV operators may be removed from a queue. For example, an EV operator may remove themselves from a queue. As another example, an EV operator may be removed from a queue if they are in the queue longer than the time set by the EV operator (either by duration or specific time period set by the EV operator). As another example, an EV operator may complete the process of being queued, starting a charging session, charging their vehicle, and ending the session. As another example, the host may remove an EV operator from a queue. As another example, an EV operator may be removed from a queue as part of an automatic purge (e.g., the EV operator was in the queue longer than the service or host defined time limit).

As another example, an EV operator whose location has been determined to be farther than a predefined limit (which may be defined by the host) from a charging port may be removed from the queue. For example, the network server may request the GPS location of a mobile device of the EV operator and/or the GPS location of an EV of the EV operator to determine the current location of the EV and compare the current location against the location of the charging port. If the EV operator and/or the EV is too far away from the charging port (the location exceeds a threshold value), then the service may remove the EV operator from the queue for that charging port.

Throughout this description there has been described various timers for implementing the community function described herein. These timers may each be configured by a host in some embodiments. In addition, these timers may be configured by a host to be different for different stations and/or charging ports. These timers may also be configured to be different for different types of EV operators. For example certain EV operators may receive a longer time to connect and/or disconnect their EVs than other EV operators (e.g., EV operators that are very important, management of a company, etc.).

Throughout this description various notification messages transmitted to the EV operators have been described. These notification messages may be transmitted to the EV operators in a number of ways including through text messages, instant messages, email messages, mobile application notification messages, or other types of electronic messages. In one embodiment an EV operator configures notification preferences on their account to indicate the type of messages it wants to receive (e.g., text messages, instant messages, email messages, mobile application notification messages, etc.). In one embodiment the EV operator may also configure their account to receive or not receive certain notification messages or other messages such as receiving a notification message each time their place in the queue changes, receiving requests from other EV operators to free up the charging port, and/or receiving requests from other EV operators to switch places in the queue. The notification messages may also include text that is customized by the hosts.

While embodiments have described that a charging session can be configured by a host to be limited to a maximum amount of time, in some embodiments any time in which the charging port is not capable of transferring energy to the EV is not counted against the time limit. For example, if the EV is unexpectedly disconnected from the charging port (e.g., by another person), the time of the disconnection may not count against the maximum amount of time. As another example, if the supply of energy to the charging port is interrupted (e.g., in response to receiving a demand response command that instructs the charging station to at least temporarily stop the transfer of energy through the charging port), the time of the interruption may not count against the maximum amount of time.

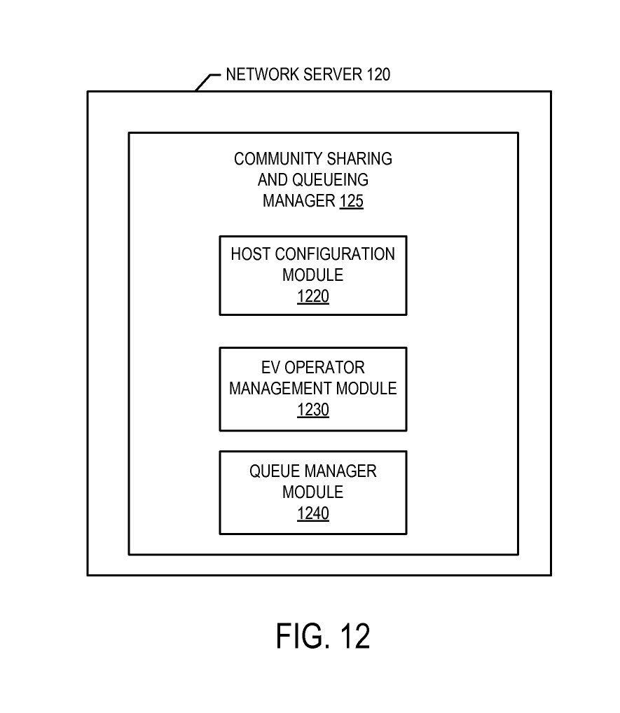

As previously described herein, in some embodiments there is a one-to-one relationship between a parking space and a charging port (e.g., a single parking space is assigned or associated with a single charging port) while in other embodiments there are multiple parking spaces assigned or associated with a single charging port. In embodiments where there are multiple parking spaces assigned or associated with a single charging port, in some embodiments a user interface for a vehicle operator to locate charging port(s) of interest (e.g., similar to FIG. 11) is configured to indicate the following depending on the appropriate circumstances: a charging port is available; a charging port is not available and no parking spaces are available; and a charging port is not available and there is at least one parking space available. Determining whether a parking space is available may be done in different ways including using a vehicle detector (e.g., an occupancy sensor that determines, based on a physical property, whether an electric vehicle is in the parking space, based on whether the EV operator has requested service at the charging station (which is a good indication that there is an EV in the corresponding parking space), and/or based on whether the EV operator has paid for parking for that parking space. FIG. 12 is a block diagram that illustrates more details of the network server 120 according to one embodiment. The network server 120 includes the community sharing and queuing manager 125. The community sharing and queuing manager 125 includes the host configuration module 1220, the EV operator configuration module 1230, and the queue manager module 1240. The host configuration module 1220 allows the hosts to configure the community and sharing parameters described herein. For example, each host may configure one or more of its charging ports to operate in community mode (be subject to queuing) and configure the parameters for the community mode (the parameters described as being configurable herein). The host configuration module 1220 is typically accessed through a graphical user interface such as a host portal website. The EV operator management module 1230 allows EV operators to manage their placement in queues (e.g., add themselves to queue(s), remove themselves from queue(s), etc.), search for charging ports they are interested in, configure notification preferences, request another EV operator free up a charging port, and/or request another EV operator to switch spots in a queue. The EV operator management module 1230 is typically accessed through a graphical user interface such as an EV operator portal website. The queue manager module 1240 manages the various queues for the charging ports.

FIG. 13 illustrates an exemplary embodiment of a charging station according to one embodiment. It should be understood that FIG. 13 illustrates an exemplary architecture of a charging station, and other, different architectures may be used in embodiments of the invention described herein. Although several components are illustrated as being included in the charging station 1300, in some embodiments additional, different, or less components may be used in the charging station 1300. For example some charging stations may not include a display or a user interface.

As illustrated in FIG. 13, the charging station 1300 includes the energy meter 1310, the current control device 1315, the charging port 1320, the volatile memory 1325, the non-volatile memory 1330 (e.g., hard drive, flash, PCM, etc.), one or more transceiver(s) 1335 (e.g., wired transceiver(s) (e.g., Ethernet, power line communication (PLC), etc.) and/or wireless transceiver(s) (e.g., 802.15.4 (e.g., ZigBee, etc.), Bluetooth, WiFi, Infrared, GPRS/GSM, CDMA, etc.)), the RFID reader 1340, the display unit 1345, the user interface 1350, and the processing system 1355 (e.g., one or more microprocessors and/or a system on an integrated circuit), which are coupled with one or more buses 1360.

The energy meter 1310 measures the amount of electricity that is flowing on the power line 1305 through the charging port 1320. While in one embodiment of the invention the energy meter 1310 measures current flow, in an alternative embodiment of the invention the energy meter 1310 measures power draw. The energy meter 1310 may be an induction coil or other devices suitable for measuring electricity. In some embodiments, the energy meter 1310 is a programmable time of use energy meter (e.g., programmed according to the prices and time periods defined by its host). While the energy meter 1310 is illustrated as being included within the charging station 1300, in other embodiments the energy meter 1310 is exterior to the charging station 1300 but capable of measuring the amount of electricity flowing on the power line 1305 through the charging port 1320.

The charging port 1320 is a power receptacle, circuitry for an attached charging cord (e.g., with a SAE J1772 connector), or circuitry for inductive charging. While FIG. 13 illustrates a single charging port 1320, the charging station 1300 may include multiple charging ports that may be of different types.

The current control device 1315 is a solid-state device that is used to control the current flowing on the power line 1305 or any other device suitable for controlling the current flowing on the power line 1305. For example, in some embodiments the current control device 1315 energizes the charging port 1320 (e.g., by completing the circuit to the power line 1305) or de-energizes the charging port 1320 (e.g., by breaking the circuit to the power line 1305). In some embodiments the current control device 1315 energizes the charging port 1320 responsive to a determination that an electric vehicle operator is authorized to use the charging port.

The RFID reader 1340 reads RFID tags from RFID enabled devices (e.g., smartcards, key fobs, contactless credit cards, etc.), embedded with RFID tag(s) of operators that want to use the charging port 1320 of the charging station 1300. For example, in some embodiments a vehicle operator can wave/swipe an RFID enabled device near the RFID reader 1330 to provide an identifier or access credentials for use of the charging port 1320. Electric vehicle operators may use the RFID reader 1340 for payment. In addition to an RFID reader, the charging station 1300 may also include a credit card reader.

The transceiver(s) 1335 transmit and receive messages. For example, the transceiver(s) 1335 may transmit authorization requests to the server, transmit charging station available messages to the server, receive charging port hold messages from the server, etc.

The display unit 1345 is used to display messages to vehicle operators including charging status, confirmation messages, error messages, notification messages, etc. The display unit 1345 may also display parking information if the charging station 1300 is also acting as a parking meter (e.g., amount of time remaining in minutes, parking violation, etc.).

The user interface 1340 allows users to interact with the charging station 1300. By way of example, the user interface 1350 allows electric vehicle operators to present user identifiers, be placed in a queue for the charging port 1320, enter in account and/or payment information, etc.

The processing system 1355 may retrieve instruction(s) from the volatile memory 1325 and/or the nonvolatile memory 1330, and execute the instructions to perform operations as previously described herein.

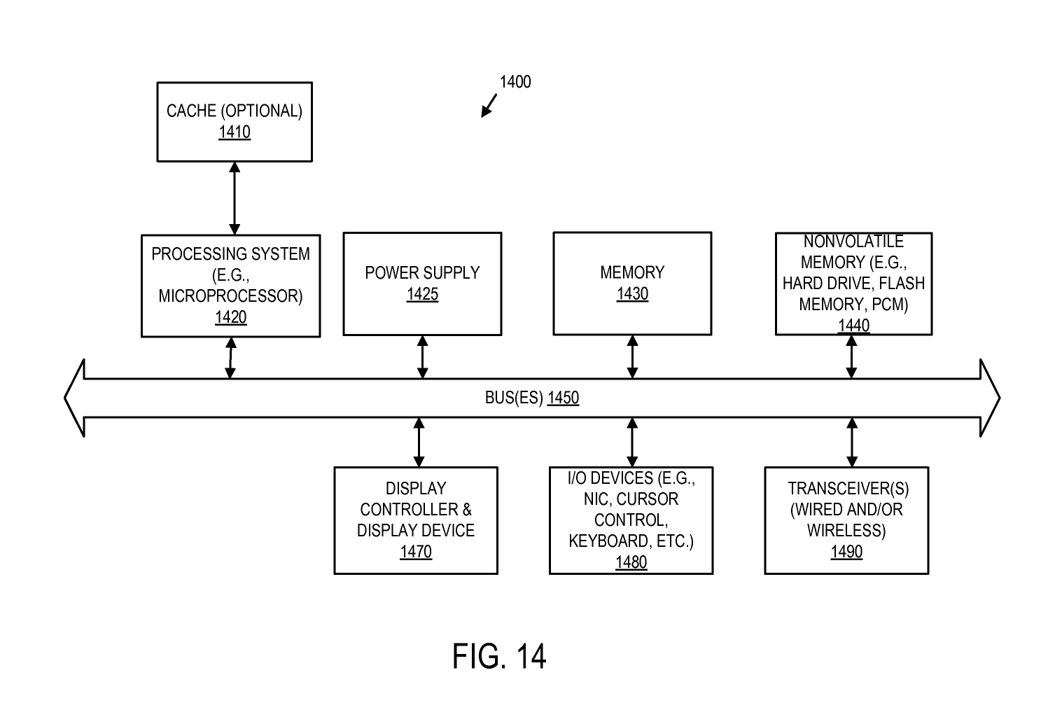

FIG. 14 is a block diagram illustrating an exemplary architecture of a data processing system that may be used in some embodiments. It should be understood that while FIG. 14 illustrates various components of a data processing system, it is not intended to represent any particular architecture or manner of interconnecting the components as such details are not germane to the present invention. The architecture of the data processing system illustrated in FIG. 14 may employed by the network server 120. It will be appreciated that other data processing systems of the service may have fewer components or more components and may also be used with the present invention.

As illustrated in FIG. 14, the data processing system 1400, which is a form of a computing device, includes the bus(es) 2450 which is coupled with the processing system 1420, power supply 1425, memory 1430, and the nonvolatile memory 1440 (e.g., a hard drive, flash memory, Phase-Change Memory (PCM), etc.). The bus(es) 1450 may be connected to each other through various bridges, controllers, and/or adapters as is well known in the art. The processing system 1420 may retrieve instruction(s) from the memory 1430 and/or the nonvolatile memory 1440, and execute the instructions to perform operations as described above. The bus 1450 interconnects the above components together and also interconnects those components to the display controller & display device 1470, Input/Output device(s) 1480 (e.g., NIC (Network Interface Card), a cursor control (e.g., mouse, touchscreen, touchpad, etc.), a keyboard, etc.), and the transceiver(s) 1290 (wired transceiver(s) (e.g., Ethernet, power line communication (PLC), etc.) and/or wireless transceiver(s) (e.g., 802.15.4 (e.g., ZigBee, etc.), Bluetooth, WiFi, Infrared, GPRS/GSM, CDMA, RFID, etc.)).

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., a charging station, a charging station network server, etc.). Such electronic devices store and communicate (internally and/or with other electronic devices over a network) code and data using machine-readable media, such as non-transitory machine-readable storage media (e.g., magnetic disks; optical disks; random access memory; read only memory; flash memory devices; phase-change memory) and transitory machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more non-transitory machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in an electric vehicle charging network server for establishing and maintaining a set of one or more queues for one or more charging ports, comprising:
determining that a charging port is available, wherein a plurality of electric vehicle operators are queued to use the charging port;
selecting a first one of the queued electric vehicle operators;
transmitting a charging port available notification message to the first electric vehicle operator, wherein the charging port available notification message indicates a time limit for which the first electric vehicle operator is required to respond in order to use the charging port to charge an electric vehicle;
receiving a message from the first electric vehicle operator prior to the time limit expiring that indicates an intention of the first electric vehicle operator to use the charging port for charging an electric vehicle belonging to the first electric vehicle operator;
transmitting a message to the first electric vehicle operator that indicates a time limit for the first electric vehicle operator to connect an electric vehicle to the charging port;
receiving a message that indicates that the charging port is available after a charging session associated with an electric vehicle associated with the first electric vehicle operator is completed;
selecting a second one of the queued electric vehicle operators;
transmitting a charging port available notification message to the second electric vehicle operator, wherein the charging port available notification message indicates a time limit for which the second electric vehicle operator is required to respond in order to use the charging port to charge an electric vehicle;
receiving a message from the second electric vehicle operator that indicates an intention of the second electric vehicle operator is passing on using the charging port;
selecting a third one of the queued electric vehicle operators;
transmitting a charging port available notification message to the third electric vehicle operator, wherein the charging port available notification message indicates a time limit for which the third electric vehicle operator is required to respond in order to use the charging port to charge an electric vehicle; and
responsive to determining that the third electric vehicle operator has not responded and the time limit has elapsed, selecting a fourth one of the queued electric vehicle operators.

2. The method of claim 1, wherein the first one of the queued electric vehicle operators is selected based on it being the electric vehicle operator in the queue the longest.

3. The method of claim 1, wherein selecting the first one of the queued electric vehicle operators takes into account different priority levels of electric vehicle operators included in the queue.

4. The method of claim 3, wherein an electric vehicle operator that has a battery only electric vehicle is given higher priority in the queue than an electric vehicle operator that has a plug-in hybrid electric vehicle.

5. The method of claim 3, wherein an electric vehicle operator that has paid a premium is given higher priority in the queue than an electric vehicle operator that has not paid the premium.

6. The method of claim 1, further comprising:
receiving a message from a fifth electric vehicle operator that indicates a request to use the charging port that is currently in use and to request the fourth electric vehicle operator to stop using the charging port;
transmitting a message to the fourth electric vehicle operator that indicates the request of the fifth electric vehicle operator to allow the fifth electric vehicle operator to use the charging port; and
responsive to receiving a message from the fourth electric vehicle operator that indicates an acceptance of the request the fifth electric vehicle operator to allow the fifth electric vehicle operator to use the charging port, transmitting a message to the fifth electric vehicle operator that indicates that the fifth electric vehicle operator is allowed use the charging port.

7. A non-transitory machine-readable storage medium that provides instructions that, when executed by a processor of an electric vehicle charging network server, cause said processor to perform operations comprising:
determining that a charging port is available, wherein a plurality of electric vehicle operators are queued to use the charging port;
selecting a first one of the queued electric vehicle operators;
transmitting a charging port available notification message to the first electric vehicle operator, wherein the charging port available notification message indicates a time limit for which the first electric vehicle operator is required to respond in order to use the charging port to charge an electric vehicle;
receiving a message from the first electric vehicle operator prior to the time limit expiring that indicates an intention of the first electric vehicle operator to use the charging port for charging an electric vehicle belonging to the first electric vehicle operator;
transmitting a message to the first electric vehicle operator that indicates a time limit for the first electric vehicle operator to connect an electric vehicle to the charging port;
receiving a message that indicates that the charging port is available after a charging session associated with an electric vehicle associated with the first electric vehicle operator is completed;
selecting a second one of the queued electric vehicle operators;
transmitting a charging port available notification message to the second electric vehicle operator, wherein the charging port available notification message indicates a time limit for which the second electric vehicle operator is required to respond in order to use the charging port to charge an electric vehicle;
receiving a message from the second electric vehicle operator that indicates an intention of the second electric vehicle operator is passing on using the charging port;
selecting a third one of the queued electric vehicle operators;
transmitting a charging port available notification message to the third electric vehicle operator, wherein the charging port available notification message indicates a time limit for which the third electric vehicle operator is required to respond in order to use the charging port to charge an electric vehicle; and
responsive to determining that the third electric vehicle operator has not responded and the time limit has elapsed, selecting a fourth one of the queued electric vehicle operators.

8. The non-transitory machine-readable storage medium of claim 7, wherein the first one of the queued electric vehicle operators is selected based on it being the electric vehicle operator in the queue the longest.

9. The non-transitory machine-readable storage medium of claim 7, wherein selecting the first one of the queued electric vehicle operators takes into account different priority levels of electric vehicle operators included in the queue.

10. The non-transitory machine-readable storage medium of claim 9, wherein an electric vehicle operator that has a battery only electric vehicle is given higher priority in the queue than an electric vehicle operator that has a plug-in hybrid electric vehicle.

11. The non-transitory machine-readable storage medium of claim 9, wherein an electric vehicle operator that has paid a premium is given higher priority in the queue than an electric vehicle operator that has not paid the premium.

12. The non-transitory machine-readable storage medium of claim 7, wherein the non-transitory machine-readable storage medium further provides instructions that, when executed by the processor, cause said processor to further perform operations comprising:
receiving a message from a fifth electric vehicle operator that indicates a request to use the charging port that is currently in use and to request the fourth electric vehicle operator to stop using the charging port;
transmitting a message to the fourth electric vehicle operator that indicates the request of the fifth electric vehicle operator to allow the fifth electric vehicle operator to use the charging port; and
responsive to receiving a message from the fourth electric vehicle operator that indicates an acceptance of the request the fifth electric vehicle operator to allow the fifth electric vehicle operator to use the charging port, transmitting a message to the fifth electric vehicle operator that indicates that the fifth electric vehicle operator is allowed use the charging port.

13. A method in an electric vehicle charging network server for establishing and maintaining a set of one or more queues for one or more charging ports, comprising:
receiving a request for a first electric vehicle operator to use a charging port for charging a first electric vehicle at a time in which the charging port is connected to a second electric vehicle belonging to a second electric vehicle operator, wherein the charging port is associated with at least two parking spaces and one of which is being occupied by the first electric vehicle and another is being occupied by the second electric vehicle;
in response to the request, placing the first electric vehicle operator in a queue to use the charging port;
responsive to determining that a charging session corresponding to the charging of the second electric vehicle is complete, performing the following:
transmitting a first message to the first electric vehicle operator that indicates that the charging port is available to use, wherein the first message indicates a time limit for which the first electric vehicle operator is required to respond in order to use the charging port;
transmitting a second message to the second electric vehicle operator that indicates that the charging session corresponding to the charging of the second electric vehicle is complete;
receiving a third message from the first electric vehicle operator prior to the time limit expiring that indicates an intention of the first electric vehicle operator to use the charging port for charging the first electric vehicle; and
transmitting a fourth message to the first electric vehicle operator that indicates a time limit for the first electric vehicle operator to connect the first electric vehicle to the charging port.

14. The method of claim 13, wherein the second message to the second electric vehicle operator further instructs the second electric vehicle operator to move the second electric vehicle.

15. The method of claim 13, wherein the fourth message also indicates to the to the first electric vehicle operator that they are allowed to disconnect the second electric vehicle from the charging port and connect the first electric vehicle to the charging port.

16. The method of claim 13, wherein the first message, second message, and fourth message is one of an email message, a text message, an instant message, and a mobile application notification message.

17. A non-transitory machine-readable storage medium that provides instructions that, when executed by a processor of an electric vehicle charging network server, cause said processor to perform operations comprising:
receiving a request for a first electric vehicle operator to use a charging port for charging a first electric vehicle at a time in which the charging port is connected to a second electric vehicle belonging to a second electric vehicle operator, wherein the charging port is associated with at least two parking spaces and one of which is being occupied by the first electric vehicle and another is being occupied by the second electric vehicle;
in response to the request, placing the first electric vehicle operator in a queue to use the charging port;
responsive to determining that a charging session corresponding to the charging of the second electric vehicle is complete, performing the following:
transmitting a first message to the first electric vehicle operator that indicates that the charging port is available to use, wherein the first message indicates a time limit for which the first electric vehicle operator is required to respond in order to use the charging port;
transmitting a second message to the second electric vehicle operator that indicates that the charging session corresponding to the charging of the second electric vehicle is complete;
receiving a third message from the first electric vehicle operator prior to the time limit expiring that indicates an intention of the first electric vehicle operator to use the charging port for charging the first electric vehicle; and
transmitting a fourth message to the first electric vehicle operator that indicates a time limit for the first electric vehicle operator to connect the first electric vehicle to the charging port.

18. The non-transitory machine-readable storage medium of claim 17, wherein the second message to the second electric vehicle operator further instructs the second electric vehicle operator to move the second electric vehicle.

19. The non-transitory machine-readable storage medium of claim 17, wherein the fourth message also indicates to the to the first electric vehicle operator that they are allowed to disconnect the second electric vehicle from the charging port and connect the first electric vehicle to the charging port.

20. The non-transitory machine-readable storage medium of claim 17, wherein the first message, second message, and fourth message is one of an email message, a text message, an instant message, and a mobile application notification message.
